(19) United States
(12) Patent Application Publication
(10) Pub. No.: US 2026/0303840 A1
(43) Pub. Date: Oct. 1, 2026

(54) BIT DEPTH SHIFTING AND RESTORATION SIGNALING FOR MACHINE TASKS

(71) Applicant: TENCENT AMERICA LLC, Palo Alto, CA (US)

(72) Inventors: Motong XU, Palo Alto, CA (US); Roman CHERNYAK, Palo Alto, CA (US); Shan LIU, Palo Alto, CA (US)

(73) Assignee: TENCENT AMERICA LLC, Palo Alto, CA (US)

(21) Appl. No.: 19/543,028

(22) Filed: Feb. 18, 2026

Related U.S. Application Data
(60) Provisional application No. 63/780,421, filed on Mar. 30, 2025.

(51) Int. Cl. H04N 19/184; H04N 19/186; H04N 19/46

(52) U.S. Cl. CPC H04N 19/184; H04N 19/186; H04N 19/46

(57) ABSTRACT

A method performed by at least one processor of a video decoder includes receiving a video bitstream comprising an encoded video sequence and bit-depth signaling information; decoding the encoded video sequence to generate a decoded video sequence; and performing a bit-depth shifting process on the decoded video sequence based on an indication that bit-depth shifting is enabled and a value of a bit-depth restoration flag included in the video bitstream.

### CROSS-REFERENCE TO RELATED APPLICATION

This application claims priority from U.S. Provisional Application No. 63/780,421 filed on Mar. 30, 2025, the disclosure of which is incorporated herein by reference in its entirety.

### FIELD

This disclosure is directed to bit-depth shifting and restoration signaling for machine tasks.

### BACKGROUND

Video compression can be used for not only human but also machine consumptions. Recently an activity was established under ISO/IEC JTC 1 SC 29 WG 4 for standardization of Video Coding for Machines (VCM). VCM's reference model uses traditional video codecs as the core codec. In existing methods, the bit-depth of a decoded sequence can be restored at the decoder according to signaled syntax, and a quality enhancement method is employed. This invention improves flexibility and signaling efficiency.

### SUMMARY

According to an aspect of the disclosure, a method performed by at least one processor of a video decoder includes receiving a video bitstream comprising an encoded video sequence and bit-depth signaling information; decoding the encoded video sequence to generate a decoded video sequence; and performing a bit-depth shifting process on the decoded video sequence based on an indication that bit-depth shifting is enabled and a value of a bit-depth restoration flag included in the video bitstream.

According to an aspect of the disclosure, a method performed by at least one processor in an encoder includes receiving a video sequence; performing a bit-depth shifting process on the video sequence to generate a transformed video sequence; encoding the transformed video sequence to generate an encoded video sequence; and generating a video bitstream comprising the encoded video sequence and an indication that bit-depth shifting is enabled and a bit-depth restoration flag.

According to an aspect of the disclosure, a non-transitory computer readable medium storing a video bitstream that is decoded by a method includes: receiving a video bitstream comprising an encoded video sequence and bit-depth signaling information; decoding the encoded video sequence to generate a decoded video sequence; and performing a bit-depth shifting process on the decoded video sequence based on an indication that bit-depth shifting is enabled and a value of a bit-depth restoration flag included in the video bitstream.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of a block diagram of a communication system, in accordance with embodiments of the present disclosure.

FIG. 2 is a schematic illustration of a block diagram of a streaming system, in accordance with embodiments of the present disclosure.

FIG. 3 is a schematic illustration of a simplified block diagram of a decoder in accordance with an embodiment.

FIG. 4 is a schematic illustration of a simplified block diagram of an encoder in accordance with an embodiment.

FIG. 5 is flowchart of an example process for performing bit-depth shifting and restoration signaling for machine tasks in accordance with an embodiment.

FIG. 6 illustrates an example computer diagram, in accordance with embodiments of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

The embodiments of the present disclosure are directed to bit-depth shifting and restoration signaling for machine tasks. As an example, a machine may refer to a camera that has a task of object tracking.

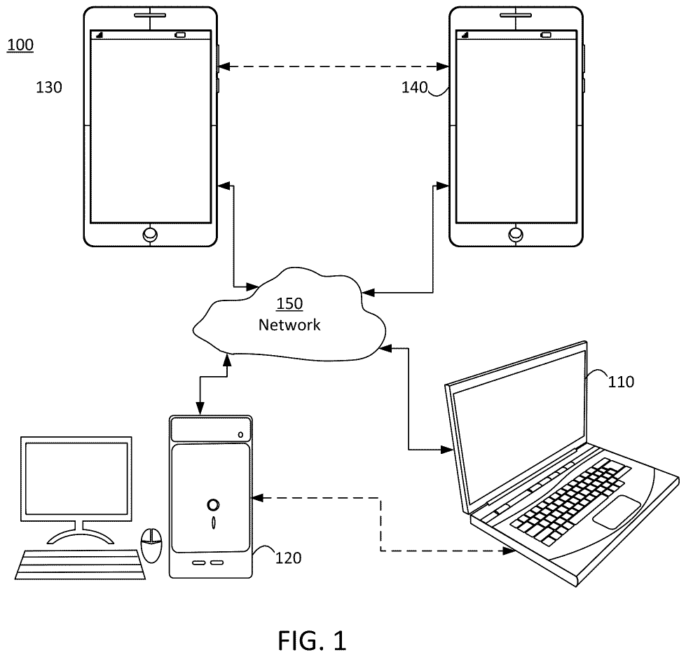

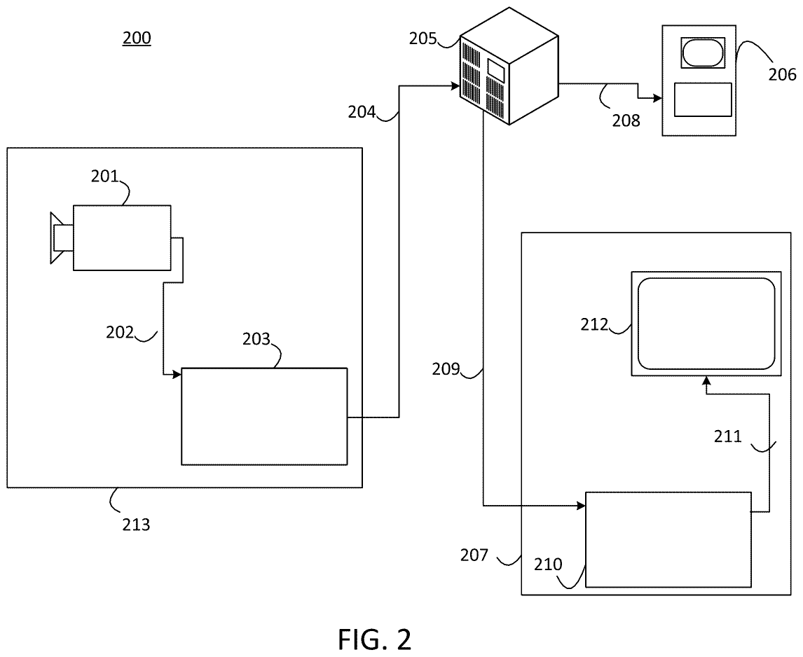

With reference to FIGS. 1-2, one or more embodiments of the present disclosure for implementing encoding and decoding structures of the present disclosure are described.

FIG. 1 illustrates a simplified block diagram of a communication system 100 according to an embodiment of the present disclosure. The system 100 may include at least two terminals 110, 120 interconnected via a network 150. For unidirectional transmission of data, a first terminal 110 may code video data, which may include mesh data, at a local location for transmission to the other terminal 120 via the network 150. The second terminal 120 may receive the coded video data of the other terminal from the network 150, decode the coded data and display the recovered video data. Unidirectional data transmission may be common in media serving applications and the like.

FIG. 1 illustrates a second pair of terminals 130, 140 provided to support bidirectional transmission of coded video that may occur, for example, during videoconferencing. For bidirectional transmission of data, each terminal 130, 140 may code video data captured at a local location for transmission to the other terminal via the network 150. Each terminal 130, 140 also may receive the coded video data transmitted by the other terminal, may decode the coded data and may display the recovered video data at a local display device.

In FIG. 1, the terminals 110-140 may be, for example, servers, personal computers, and smart phones, and/or any other type of terminals. For example, the terminals (110-140) may be laptop computers, tablet computers, media players and/or dedicated video conferencing equipment. The network 150 represents any number of networks that convey coded video data among the terminals 110-140 including, for example, wireline and/or wireless communication networks. The communication network 150 may exchange data in circuit-switched and/or packet-switched channels. Representative networks include telecommunications networks, local area networks, wide area networks, and/or the Internet. For the purposes of the present discussion, the architecture and topology of the network 150 may be immaterial to the operation of the present disclosure unless explained herein below.

FIG. 2 illustrates, as an example of an application for the disclosed subject matter, a placement of a video encoder and decoder in a streaming environment. The disclosed subject matter may be used with other video enabled applications, including, for example, video conferencing, digital TV, storing of compressed video on digital media including CD, DVD, memory stick and the like, and so on.

As illustrated in FIG. 2, a streaming system (200) may include a capture subsystem (213) that includes a video source (201) and an encoder (203). The streaming system (200) may further include at least one streaming server (205) and/or at least one streaming client (206).

The video source (201) may create, for example, a stream (202) that includes a 3D mesh and metadata associated with the 3D mesh. The video source (201) may include, for example, 3D sensors (e.g. depth sensors) or 3D imaging technology (e.g. digital camera(s)), and a computing device that is configured to generate the 3D mesh using the data received from the 3D sensors or the 3D imaging technology. The sample stream (202), which may have a high data volume when compared to encoded video bitstreams, may be processed by the encoder (203) coupled to the video source (201). The encoder (203) may include hardware, software, or a combination thereof to enable or implement aspects of the disclosed subject matter as described in more detail below. The encoder (203) may also generate an encoded video bitstream (204). The encoded video bitstream (204), which may have a lower data volume when compared to the uncompressed stream (202), may be stored on a streaming server (205) for future use. One or more streaming clients (206) and (207) may access the streaming server (205) to retrieve video bit streams (208) and (209), respectively that may be copies of the encoded video bitstream (204).

The streaming clients stream (209), which is an incoming copy of the encoded video bitstream (204), and create an outgoing video sample stream (211) that may be rendered on the display (212) or another rendering device (not depicted). In some streaming systems, the video bitstreams (204), (208), and (209) may be encoded according to certain video coding/compression standards.

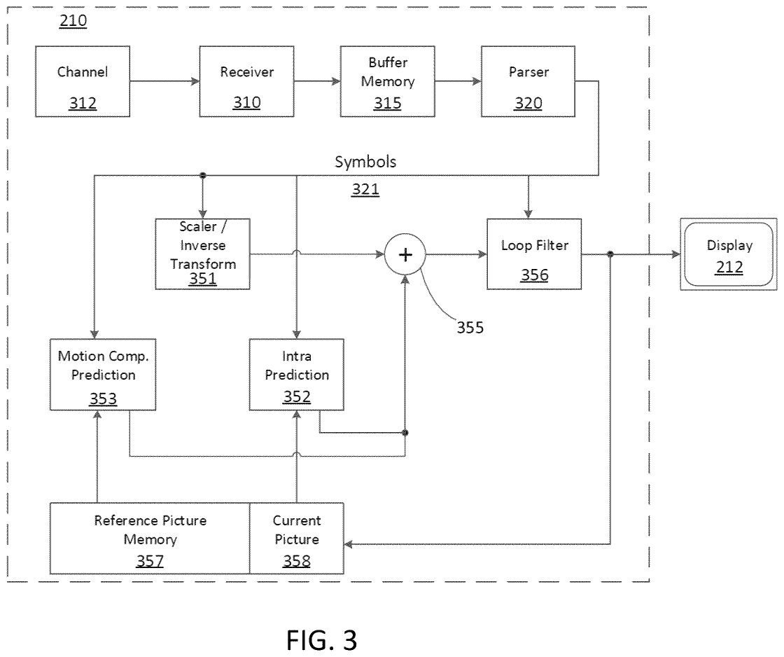

FIG. 3 illustrates an example functional block diagram of a video decoder (210) that is attached to a display (212) according to an embodiment of the present disclosure.

The video decoder (210) may include a channel (312), receiver (310), a buffer memory (315), an entropy decoder/parser (320), a scaler/inverse transform unit (351), an intra prediction unit (352), a Motion Compensation Prediction unit (353), an aggregator (355), a loop filter unit (356), reference picture memory (357), and current picture memory ( ). In at least one embodiment, the video decoder (210) may include an integrated circuit, a series of integrated circuits, and/or other electronic circuitry. The video decoder (210) may also be partially or entirely embodied in software running on one or more CPUs with associated memories.

In this embodiment, and other embodiments, the receiver (310) may receive one or more coded video sequences to be decoded by the decoder (210) one coded video sequence at a time, where the decoding of each coded video sequence is independent from other coded video sequences. The coded video sequence may be received from the channel (312), which may be a hardware/software link to a storage device which stores the encoded video data. The receiver (310) may receive the encoded video data with other data, for example, coded audio data and/or ancillary data streams, that may be forwarded to their respective using entities (not depicted). The receiver (310) may separate the coded video sequence from the other data. To combat network jitter, the buffer memory (315) may be coupled in between the receiver (310) and the entropy decoder/parser (320) (“parser” henceforth). When the receiver (310) is receiving data from a store/forward device of sufficient bandwidth and controllability, or from an isosynchronous network, the buffer (315) may not be used, or can be small. For use on best effort packet networks such as the Internet, the buffer (315) may be required, can be comparatively large, and can be of adaptive size.

The video decoder (210) may include a parser (320) to reconstruct symbols (321) from the entropy coded video sequence. Categories of those symbols include, for example, information used to manage operation of the decoder (210), and potentially information to control a rendering device such as a display (212) that may be coupled to a decoder as illustrated in FIG. 2. The control information for the rendering device(s) may be in the form of, for example, Supplementary Enhancement Information (SEI) messages or Video Usability Information (VUI) parameter set fragments (not depicted). The parser (320) may parse/entropy-decode the coded video sequence received. The coding of the coded video sequence can be in accordance with a video coding technology or standard, and can follow principles well known to a person skilled in the art, including variable length coding, Huffman coding, arithmetic coding with or without context sensitivity, and so forth. The parser (320) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (320) may also extract from the coded video sequence information such as transform coefficients, quantizer parameter values, motion vectors, and so forth.

The parser (320) may perform entropy decoding/parsing operation on the video sequence received from the buffer (315), so to create symbols (321).

Reconstruction of the symbols (321) can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser (320). The flow of such subgroup control information between the parser (320) and the multiple units below is not depicted for clarity.

Beyond the functional blocks already mentioned, decoder 210 can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

One unit may be the scaler/inverse transform unit (351). The scaler/inverse transform unit (351) may receive quantized transform coefficient as well as control information, including which transform to use, block size, quantization factor, quantization scaling matrices, etc. as symbol(s) (321) from the parser (320). The scaler/inverse transform unit (351) can output blocks including sample values that can be input into the aggregator (355).

In some cases, the output samples of the scaler/inverse transform (351) can pertain to an intra coded block; that is: a block that is not using predictive information from previously reconstructed pictures, but can use predictive information from previously reconstructed parts of the current picture. Such predictive information can be provided by an intra picture prediction unit (352). In some cases, the intra picture prediction unit (352) generates a block of the same size and shape of the block under reconstruction, using surrounding already reconstructed information fetched from the current (partly reconstructed) picture from the current picture memory (358). The aggregator (355), in some cases, adds, on a per sample basis, the prediction information the intra prediction unit (352) has generated to the output sample information as provided by the scaler/inverse transform unit (351).

In other cases, the output samples of the scaler/inverse transform unit (351) can pertain to an inter coded, and potentially motion compensated block. In such a case, a Motion Compensation Prediction unit (353) can access reference picture memory (357) to fetch samples used for prediction. After motion compensating the fetched samples in accordance with the symbols (321) pertaining to the block, these samples can be added by the aggregator (355) to the output of the scaler/inverse transform unit (351) (in this case called the residual samples or residual signal) so to generate output sample information. The addresses within the reference picture memory (357), from which the Motion Compensation Prediction unit (353) fetches prediction samples, can be controlled by motion vectors. The motion vectors may be available to the Motion Compensation Prediction unit (353) in the form of symbols (321) that can have, for example, X, Y, and reference picture components. Motion compensation also can include interpolation of sample values as fetched from the reference picture memory (357) when sub-sample exact motion vectors are in use, motion vector prediction mechanisms, and so forth.

The output samples of the aggregator (355) can be subject to various loop filtering techniques in the loop filter unit (356). Video compression technologies can include in-loop filter technologies that are controlled by parameters included in the coded video bitstream and made available to the loop filter unit (356) as symbols (321) from the parser (320), but can also be responsive to meta-information obtained during the decoding of previous (in decoding order) parts of the coded picture or coded video sequence, as well as responsive to previously reconstructed and loop-filtered sample values.

The output of the loop filter unit (356) can be a sample stream that can be output to a render device such as a display (212), as well as stored in the reference picture memory (357) for use in future inter-picture prediction.

Certain coded pictures, once fully reconstructed, can be used as reference pictures for future prediction. Once a coded picture is fully reconstructed and the coded picture has been identified as a reference picture (by, for example, parser (320)), the current reference picture can become part of the reference picture memory (357), and a fresh current picture memory can be reallocated before commencing the reconstruction of the following coded picture.

The video decoder (210) may perform decoding operations according to a predetermined video compression technology that may be documented in a standard, such as ITU-T Rec. H.265. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an embodiment, the receiver (310) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or SNR enhancement layers, redundant slices, redundant pictures, forward error correction codes, and so on.

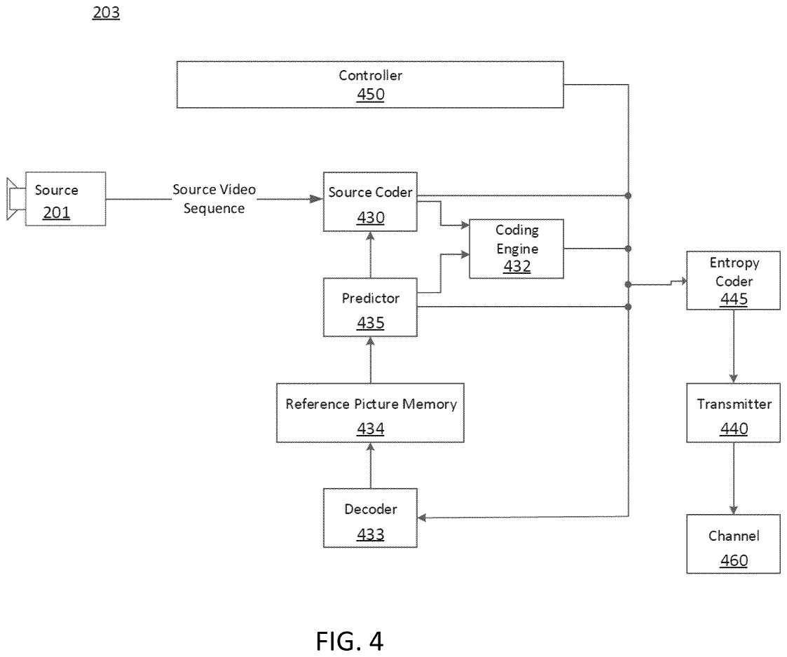

FIG. 4 illustrates an example functional block diagram of a video encoder (203) associated with a video source (201) according to an embodiment of the present disclosure.

The video encoder (203) may include, for example, an encoder that is a source coder (430), a coding engine (432), a (local) decoder (433), a reference picture memory (434), a predictor (435), a transmitter (440), an entropy coder (445), a controller (450), and a channel (460).

The encoder (203) may receive video samples from a video source (201) (that is not part of the encoder) that may capture video image(s) to be coded by the encoder (203).

The video source (201) may provide the source video sequence to be coded by the encoder (203) in the form of a digital video sample stream that can be of any suitable bit depth (for example: 8 bit, 10 bit, 12 bit, . . . ), any colorspace (for example, BT.601 Y CrCB, RGB, . . . ) and any suitable sampling structure (for example Y CrCb 4:2:0, Y CrCb 4:4:4). In a media serving system, the video source (201) may be a storage device storing previously prepared video. In a videoconferencing system, the video source (203) may be a camera that captures local image information as a video sequence. Video data may be provided as a plurality of individual pictures that impart motion when viewed in sequence. The pictures themselves may be organized as a spatial array of pixels, wherein each pixel can comprise one or more sample depending on the sampling structure, color space, etc. in use. A person skilled in the art can readily understand the relationship between pixels and samples. The description below focuses on samples.

According to an embodiment, the encoder (203) may code and compress the pictures of the source video sequence into a coded video sequence (443) in real time or under any other time constraints as required by the application. Enforcing appropriate coding speed is one function of controller (450). The controller (450) may also control other functional units as described below and may be functionally coupled to these units. The coupling is not depicted for clarity. Parameters set by the controller (450) can include rate control related parameters (picture skip, quantizer, lambda value of rate-distortion optimization techniques, . . . ), picture size, group of pictures (GOP) layout, maximum motion vector search range, and so forth. A person skilled in the art can readily identify other functions of controller (450) as they may pertain to video encoder (203) optimized for a certain system design.

Some video encoders operate in what a person skilled in the are readily recognizes as a “coding loop”. As an oversimplified description, a coding loop can consist of the encoding part of the source coder (430) (responsible for creating symbols based on an input picture to be coded, and a reference picture(s)), and the (local) decoder (433) embedded in the encoder (203) that reconstructs the symbols to create the sample data that a (remote) decoder also would create when a compression between symbols and coded video bitstream is lossless in certain video compression technologies. That reconstructed sample stream may be input to the reference picture memory (434). As the decoding of a symbol stream leads to bit-exact results independent of decoder location (local or remote), the reference picture memory content is also bit exact between a local encoder and a remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is known to a person skilled in the art.

The operation of the “local” decoder (433) can be the same as of a “remote” decoder (210), which has already been described in detail above in conjunction with FIG. 3. However, as symbols are available and en/decoding of symbols to a coded video sequence by the entropy coder (445) and the parser (320) can be lossless, the entropy decoding parts of decoder (210), including channel (312), receiver (310), buffer (315), and parser (320) may not be fully implemented in the local decoder (433).

An observation that can be made at this point is that any decoder technology, except the parsing/entropy decoding that is present in a decoder, may need to be present, in substantially identical functional form in a corresponding encoder. For this reason, the disclosed subject matter focuses on decoder operation. The description of encoder technologies can be abbreviated as they may be the inverse of the comprehensively described decoder technologies. Only in certain areas a more detail description is required and provided below.

As part of its operation, the source coder (430) may perform motion compensated predictive coding, which codes an input frame predictively with reference to one or more previously-coded frames from the video sequence that were designated as “reference frames.” In this manner, the coding engine (432) codes differences between pixel blocks of an input frame and pixel blocks of reference frame(s) that may be selected as prediction reference(s) to the input frame.

The local video decoder (433) may decode coded video data of frames that may be designated as reference frames, based on symbols created by the source coder (430). Operations of the coding engine (432) may advantageously be lossy processes. When the coded video data may be decoded at a video decoder (not shown in FIG. 4), the reconstructed video sequence typically may be a replica of the source video sequence with some errors. The local video decoder (433) replicates decoding processes that may be performed by the video decoder on reference frames and may cause reconstructed reference frames to be stored in the reference picture memory (434). In this manner, the encoder (203) may store copies of reconstructed reference frames locally that have common content as the reconstructed reference frames that will be obtained by a far-end video decoder (absent transmission errors).

The predictor (435) may perform prediction searches for the coding engine (432). That is, for a new frame to be coded, the predictor (435) may search the reference picture memory (434) for sample data (as candidate reference pixel blocks) or certain metadata such as reference picture motion vectors, block shapes, and so on, that may serve as an appropriate prediction reference for the new pictures. The predictor (435) may operate on a sample block-by-pixel block basis to find appropriate prediction references. In some cases, as determined by search results obtained by the predictor (435), an input picture may have prediction references drawn from multiple reference pictures stored in the reference picture memory (434).

The controller (450) may manage coding operations of the video coder (430), including, for example, setting of parameters and subgroup parameters used for encoding the video data.

Output of all aforementioned functional units may be subjected to entropy coding in the entropy coder (445). The entropy coder translates the symbols as generated by the various functional units into a coded video sequence, by loss-less compressing the symbols according to technologies known to a person skilled in the art as, for example Huffman coding, variable length coding, arithmetic coding, and so forth.

The transmitter (440) may buffer the coded video sequence(s) as created by the entropy coder (445) to prepare it for transmission via a communication channel (460), which may be a hardware/software link to a storage device which would store the encoded video data. The transmitter (440) may merge coded video data from the video coder (430) with other data to be transmitted, for example, coded audio data and/or ancillary data streams (sources not shown).

The controller (450) may manage operation of the encoder (203). During coding, the controller (450) may assign to each coded picture a certain coded picture type, which may affect the coding techniques that may be applied to the respective picture. For example, pictures often may be assigned as an Intra Picture (I picture), a Predictive Picture (P picture), or a Bi-directionally Predictive Picture (B Picture).

An Intra Picture (I picture) may be one that may be coded and decoded without using any other frame in the sequence as a source of prediction. Some video codecs allow for different types of Intra pictures, including, for example Independent Decoder Refresh (IDR) Pictures. A person skilled in the art is aware of those variants of I pictures and their respective applications and features.

A Predictive picture (P picture) may be one that may be coded and decoded using intra prediction or inter prediction using at most one motion vector and reference index to predict the sample values of each block.

A Bi-directionally Predictive Picture (B Picture) may be one that may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

The video coder (203) may perform coding operations according to a predetermined video coding technology or standard, such as ITU-T Rec. H.265. In its operation, the video coder (203) may perform various compression operations, including predictive coding operations that exploit temporal and spatial redundancies in the input video sequence. The coded video data, therefore, may conform to a syntax specified by the video coding technology or standard being used.

In an embodiment, the transmitter (440) may transmit additional data with the encoded video. The video coder (430) may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and so on.

The proposed methods may be used separately or combined in any order. Further, each of the methods (or embodiments), encoder, and decoder may be implemented by processing circuitry (e.g., one or more processors or one or more integrated circuits). In one example, the one or more processors execute a program that is stored in a non-transitory computer-readable medium.

According to one or more embodiments, the enabling flag of bit-depth shift for sequence restoration and picture restoration are signaled. When the enabling flag of bit-depth shift equals to 1, the syntax of bit-depth shift is signaled. Otherwise, the syntax of the bit-depth shift is not signaled. The number of bits right shifted for luma at the encoder and the number of bits left shifted for chroma at the decoder are signaled in the bitstream. When the number of bits right shifted for luma at the encoder is greater than 0, the enabling flag of bit-depth restoration method and the enabling flag of luma enhancement method are signaled. If the enabling flag of bit-depth restoration equals 0, the number of bits left shifted for luma at the decoder is signaled.

TABLE 1

| | Descriptor |
|---|---|
| sequence_restoration_data_rbsp( ) { | |
| ... | |
| srd_bit_depth_shift_enabled_flag | u(1) |
| if( srd_bit_depth_shift_enabled_flag ) | |
| bit_depth_shift( ) | |
| ... | |
| } | |

TABLE 2

| | Descriptor |
|---|---|
| picture_restoration_data_rbsp( ) { | |
| ... | |
| prd_bit_depth_shift_enabled_flag | u(1) |
| if( prd_bit_depth_shift_enabled_flag ) | |
| bit_depth_shift( ) | |
| ... | |
| } | |

TABLE 3

| | Descriptor |
|---|---|
| bit_depth_shift( ) { | |
| bit_depth_right_shift_luma | u(3) |
| if( bit_depth_right_shift_luma > 0 ) { | |
| bit_depth_restoration_flag | u(1) |
| if( bit_depth_restoration == 0 ) { | |
| bit_depth_left_shift luma | u(3) |
| } | |
| bit_depth_luma_enhance | u(1) |
| } | |
| bit_depth_left_shift_chroma | u(3) |
| } | |

In one or more examples, srd_bit_depth_shift_enabled_flag equal to 1 specifies that bit-depth shift is enabled, and srd_bit_depth_shift_enabled_flag equal to 0 specifies that bit-depth shift is disabled.

In one or more examples, prd_bit_depth_shift_enabled_flag equal to 1 specifies that bit-depth shift is enabled, and prd_bit_depth_shift_enabled_flag equal to 0 specifies that bit-depth shift is disabled.

In one or more examples, bit_depth_right_shift_luma specifies the number of bits that luma sample values are right shifted by the encoder. When not present, the value of bit_depth_right_shift_luma is inferred to be equal to 0. The values of bit_depth_right_shift_luma may be in the range of 0 to 7, inclusive.

In one or more examples, bit_depth_restoration_flag equal to 1 specifies that the bit-depth restoration method is enabled, and bit_depth_restoration_flag equal to 0 specifies that the bit-depth restoration method is disabled.

In one or more examples, bit_depth_left_shift_luma specifies the number of bits that luma sample values are left shifted by the decoder. When not present, the value of bit_depth_left_shift_luma may be inferred to be equal to 0. The values of bit_depth_left_shift_luma may be in the range of 0 to 7, inclusive. The value of bit_depth_left_shift_luma may not exceed the value of bit_depth_right_shift_luma.

In one or more examples, bit_depth_luma_enhance equal to 1 specifies that luma enhancement is enabled, and bit_depth_luma_enhance equal to 0 specifies that luma enhancement is disabled. When not present, the value of bit_depth_luma_enhance may be inferred to be equal to 0.

In one or more examples, bit_depth_left_shift_chroma specifies the number of bits that chroma sample values are left shifted. When not present, the value of bit_depth_left_shift_chroma may be inferred to be equal to 0. The values of bit_depth_left_shift_chroma shall be in the range of 0 to 7, inclusive. The value of bit_depth_left_shift_chroma may not exceed the value of bit_depth_right_shift_chroma.

According to one or more embodiments, the enabling flag of quality enhancement for luma may be signaled only if the enabling flag of bit-depth restoration is zero.

TABLE 4

| | Descriptor |
|---|---|
| bit_depth_shift( ) { | |
| bit_depth_right_shift_luma | u(3) |
| if( bit_depth_right_shift_luma > 0 ) { | |
| bit_depth_restoration_flag | u(1) |
| if( bit_depth_restoration_flag == 0 ) { | |
| bit_depth_left_shift_luma | u(3) |
| bit_depth_luma_enhance | u(1) |
| } | |
| } | |
| bit_depth_left_shift_chroma | u(3) |
| } | |

According to one or more embodiments, the enabling flag of quality enhancement for luma may be signaled depending on the value of the number of bits left shifted for luma at the decoder. In one or more examples, the enabling flag of quality enhancement for luma may be signaled only when the value of the number of bits left shifted for luma at the decoder equals an integer value. The value may be predefined or signaled in the bitstream.

In one or more examples, the enabling flag of quality enhancement for luma is signaled only when the value of the number of bits left shifted for luma at the decoder equals to 0.

TABLE 5

| | Descriptor |
|---|---|
| bit_depth_shift( ) { | |
| bit_depth_right_shift_luma | u(3) |
| if( bit_depth_right_shift_luma > 0 ) { | |
| bit_depth_restoration_flag | u(1) |
| if( bit_depth_restoration_flag == 0 ) { | |
| bit_depth_left_shift_luma | u(3) |
| if( bit_depth left_shift_luma == 0) | |
| bit_depth_luma_enhance | u(1) |
| } | |
| } | |
| } | |
| bit_depth_left_shift_chroma | u(3) |
| } | |

In one or more examples, the enabling flag of quality enhancement for luma may be signaled only when the value of the number of bits left shifted for luma at the decoder is smaller than an integer value. The value may be predefined or signaled in the bitstream. In one more examples, the enabling flag of quality enhancement for luma is signaled only when the value of the number of bits left shifted for luma at the decoder is smaller than the number of bits right shifted for luma at the encoder.

TABLE 6

| | Descriptor |
|---|---|
| bit_depth_shift( ) { | |
| bit_depth_right_shift_luma | u(3) |
| if( bit_depth_right_shift_luma > 0 ) { | |
| bit_depth_restoration_flag | u(1) |
| if( bit_depth_restoration_flag == 0 ) { | |
| bit_depth_left_shift_luma | u(3) |
| if( bit_depth_left shift luma< | |
| bit_depth_right_shift luma ) | |
| bit_depth_luma_enhance | u(1) |
| } | |
| } | |
| } | |
| bit_depth_left_shift_chroma | u(3) |
| } | |

According to one or more embodiments, the number of bits right shifted for chroma at the encoder is signaled in the bitstream. The number of bits left shifted for chroma at the decoder is signaled in the bitstream only when the number of bits right shifted for chroma at the decoder is larger than 0.

TABLE 7

| | Descriptor |
|---|---|
| bit_depth_shift( ) { | |
| bit_depth_right_shift_luma | u(3) |
| if( bit_depth_right_shift_luma > 0 ) { | |
| bit_depth_restoration_flag | u(1) |
| if( bit_depth_restoration_flag == 0 ) { | |
| bit_depth_left_shift_luma | u(3) |
| } | |
| bit_depth_luma_enhance | u(1) |
| } | |
| bit_depth_right_shift_chroma | u(1) |
| if( bit_depth_right_shift_chroma>0 ) { | |
| bit_depth_left_shift_chroma | u(3) |
| } | |
| } | |

In one or more examples, bit_depth_right_shift_chroma specifies the number of bits that chroma sample values are right shifted by the encoder. When not present, the value of bit_depth_right_shift_chroma is inferred to be equal to 0. The values of bit_depth_right_shift_chroma shall be in the range of 0 to 7, inclusive.

According to one or more embodiments, the number of bits right shifted for chroma at the encoder is signaled in the bitstream. The enabling flag of bit-depth restoration method for chroma component is signaled in the bitstream only when the number of bits right shifted for chroma at the encoder is larger than 0. The number of bits left shifted for chroma at the decoder is signaled in the bitstream only when the enabling flag of bit-depth restoration for chroma is not equal to 0.

TABLE 8

| | Descriptor |
|---|---|
| bit_depth_shift( ) { | |
| bit_depth_right_shift_luma | u(3) |
| if( bit_depth_right_shift_luma > 0 ) { | |
| bit_depth_restoration_luma_flag | u(1) |
| if( bit_depth_restoration luma_flag == 0 ) { | |
| bit_depth_left_shift_luma | u(3) |
| } | |
| bit_depth_luma_enhance | u(1) |
| } | |
| bit_depth_right_shift_chroma | u(1) |
| if( bit_depth_right_shift_chroma>0 ) { | |
| bit_depth_restoration_chroma_flag | u(1) |
| if( bit_depth_restoration_chroma_flag == 0 ) { | |
| bit_depth_left_shift_chroma | u(3) |
| } | |
| } | |
| } | |

In one or more examples, bit_depth_restoration_luma_flag equal to 1 specifies that the bit-depth restoration method for luma component is enabled, and bit_depth_restoration_flag equal to 0 specifies that the bit-depth restoration method for luma component is disabled. In one or more examples, bit_depth_restoration_chroma_flag equal to 1 specifies that the bit-depth restoration method for chroma component is enabled. bit_depth_restoration_flag equal to 1 specifies that the bit-depth restoration method for chroma component is disabled.

In one or more examples, the number of bits right shifted for chroma at the encoder is signaled in the bitstream. The enabling flag of bit-depth restoration method for chroma component is signaled in the bitstream only when the number of bits right shifted for chroma at the encoder is larger than 0. The number of bits left shifted for luma and the enabling flag of quality enhancement for luma are signaled only if the enabling flag of bit-depth restoration for luma is zero.

TABLE 9

| | Descriptor |
|---|---|
| bit_depth_shift( ) { | |
| bit_depth_right_shift_luma | u(3) |
| if( bit_depth_right_shift_luma > 0 ) { | |
| bit_depth_restoration_luma_flag | u(1) |
| if( bit_depth_restoration luma_flag == 0 ) { | |
| bit_depth_left_shift_luma | u(3) |
| bit_depth_luma_enhance | u(1) |
| } | |
| } | |
| bit_depth_right_shift_chroma | u(1) |
| if( bit_depth_right_shift_chroma>0 ) { | |
| bit_depth_restoration_chroma_flag | u(1) |
| if( bit_depth_restoration_chroma_flag == 0 ) { | |
| bit_depth_left_shift_chroma | u(3) |
| } | |
| } | |
| } | |

According to one or more embodiments, number of bits right shifted for chroma at the encoder is signaled in the bitstream. The enabling flag of bit-depth restoration method for chroma component may be signaled in the bitstream only when the number of bits right shifted for chroma at the encoder is larger than 0. The number of bits left shifted for luma signaled only if the enabling flag of bit-depth restoration for luma is zero. The enabling flag of quality enhancement for luma may be signaled depending on the value of the number of bits left shifted for luma at the decoder.

In one or more examples, the enabling flag of quality enhancement for luma is signaled only when the value of the number of bits left shifted for luma at the decoder equals an integer value. The value is predefined or signaled in the bitstream. In one or more examples, the enabling flag of quality enhancement for luma may be signaled only when the value of the number of bits left shifted for luma at the decoder equals to 0.

TABLE 10

| | Descriptor |
|---|---|
| bit_depth_shift( ) { | |
| bit_depth_right_shift_luma | u(3) |
| if( bit_depth_right_shift_luma > 0 ) { | |
| bit_depth_restoration_luma_flag | u(1) |
| if( bit_depth_restoration_luma_flag == 0 ) { | |
| bit_depth_left shift luma | u(3) |
| if(bit_depth_left_shift_luma == 0) { | |
| bit_depth_luma enhance | u(1) |
| } | |
| } | |
| } | |
| bit_depth_right_shift_chroma | u(1) |
| if( bit_depth_right_shift_chroma>0 ) { | |
| bit_depth restoration_chroma_flag | u(1) |
| if( bit_depth_restoration_chroma_flag == 0 ) { | |
| bit_depth_left_shift_chroma | u(3) |
| } | |
| } | |
| } | |

In one or more examples, the enabling flag of quality enhancement for luma may be signaled only when the value of the number of bits left shifted for luma at the decoder is smaller than an integer value. The value may be predefined or signaled in the bitstream.

In one example, the enabling flag of quality enhancement for luma is signaled only when the value of the number of bits left shifted for luma at the decoder is smaller than the number of bits right shifted for luma at the encoder.

TABLE 11

| | Descriptor |
|---|---|
| bit_depth_shift( ) { | |
| bit_depth_right_shift_luma | u(3) |
| if( bit_depth_right_shift_luma > 0) { | |
| bit_depth_restoration_luma_flag | u(1) |
| if( bit_depth_restoration_luma_flag == 0 ) { | |
| bit_depth_left_shift_luma | u(3) |
| if(bit_depth_left_shift luma< | |
| bit_depth_right_shift_luma) { | |
| bit_depth_luma_enhance | u(1) |
| } | |
| } | |
| } | |
| bit_depth_right_shift_chroma | u(1) |
| if( bit_depth_right_shift_chroma>0 ) { | |
| bit_depth_restoration_chroma_flag | u(1) |
| if( bit_depth_restoration_chroma_flag == 0 ) { | |
| bit_depth_left_shift_chroma | u(3) |
| } | |
| } | |
| } | |

According to one or more embodiments, the enabling flag of bit-depth restoration method is signaled in the bitstream if either the number of bits right shifted for luma at the encoder and the number of bits right shifted for chroma at the encoder is not equal to 0.

TABLE 12

| | Descriptor |
|---|---|
| bit_depth_shift( ) { | |
| bit_depth_right_shift_luma | u(3) |
| bit_depth_right_shift_chroma | u(3) |
| if( bit_depth_right_shift_luma \|\| bit_depth_ | |
| right_shift_chroma ) { | |
| bit_depth_restoration_flag | u(1) |
| if(bit_depth_right_shift_luma)&& | |
| bit_depth_restoration_flag == 0) | |
| { | |
| bit_depth_luma_enhance | u(1) |
| if(bit_depth_restoration_flag == 0){ | |
| bit_depth_left_shift_luma | u(3) |
| } | |
| } | |
| if(bit_depth_right_shift_chroma) { | |
| if(bit_depth_restoration_flag == 0){ | |
| bit_depth_left_shift_chroma | u(3) |
| } | |
| } | |
| } | |
| } | |

According to one or more embodiments, the enabling flag of bit-depth restoration method is signaled in the bitstream if either the number of bits right shifted for luma at the encoder and the number of bits right shifted for chroma at the encoder is not equal to 0. The number of bits left shifted for luma and the enabling flag of quality enhancement for luma are signaled only if the number of bits right shifted for luma at the encoder is larger than 0 and the enabling flag of bit-depth restoration method is equal to 0.

TABLE 13

| | Descriptor |
|---|---|
| bit_depth_shift( ) { | |
| bit_depth_right_shift_luma | u(3) |
| bit_depth_right_shift_chroma | u(3) |
| if( bit_depth_right_shift_luma \|\| | |
| bit_depth_right_shift_chroma ) { | |
| bit_depth_restoration_flag | u(1) |
| if(bit_depth_right_shift_luma&& | |
| bit_depth_restoration_flag == 0) | |
| { | |
| bit_depth_luma_enhance | u(1) |
| bit_depth_left_shift_luma | u(3) |
| } | |
| if(bit_depth_right_shift_chroma>0) { | |
| if(bit_depth_restoration_flag == 0){ | |
| bit_depth_left_shift chroma | u(3) |
| } | |
| } | |
| } | |
| } | |

According to one or more embodiments, the enabling flag of bit-depth restoration method is signaled in the bitstream if either the number of bits right shifted for luma at the encoder and the number of bits right shifted for chroma at the encoder is not equal to 0. The number of bits left shifted for luma may be signaled only if the number of bits right shifted for luma at the encoder is larger than 0 and the enabling flag of bit-depth restoration method is equal to 0.

In one or more examples, the enabling flag of quality enhancement for luma is signaled only when the value of the number of bits left shifted for luma at the decoder equals an integer value. The value is predefined or signaled in the bitstream. In one or more examples, the enabling flag of quality enhancement for luma is signaled only when the value of the number of bits left shifted for luma at the decoder equals to 0.

TABLE 14

| | Descriptor |
|---|---|
| bit_depth_shift( ) { | |
| bit_depth_right_shift_luma | u(3) |
| bit_depth_right_shift_chroma | u(3) |
| if( bit depth right shift luma \|\| | |
| bit depth right shift chroma | |
| bit_depth restoration_flag | u(1) |
| if(bit_depth_right_shift_luma&& | |
| bit_depth_restoration_flag == 0) | |
| { | |
| bit_depth_left_shift_luma | u(3) |
| if(bit_depth_left_shift_luma == 0){ | |
| bit_depth_luma_enhance | u(1) |
| } | |
| } | |
| if(bit_depth_right_shift_chroma) { | |
| if(bit_depth_restoration_flag == 0){ | |
| bit_depth_left_shift_chroma | u(3) |
| } | |
| } | |
| } | |
| } | |

In one or more examples, the enabling flag of quality enhancement for luma is signaled only when the value of the number of bits left shifted for luma at the decoder is smaller than an integer value. The value is predefined or signaled in the bitstream. In one or more examples, the enabling flag of quality enhancement for luma is signaled only when the value of the number of bits left shifted for luma at the decoder is smaller than the number of bits right shifted for luma at the encoder.

TABLE 15

| | Descriptor |
|---|---|
| bit_depth_shift( ) { | |
| bit_depth_right_shift_luma | u(3) |
| bit_depth_right_shift_chroma | u(3) |
| if( bit_depth_right_shift_luma \|\| | |
| bit_depth_right_shift_chroma ) { | |
| bit_depth_restoration_flag | u(1) |
| if(bit_depth_right_shift_luma&& | |
| bit_depth_restoration_flag == 0) | |
| { | |
| bit_depth_left_shift_luma | u(3) |
| if(bit_depth_left_shift_luma< | |
| bit_depth_right_shift_luma){ | |
| bit_depth_luma_enhance | u(1) |
| } | |
| } | |
| if(bit_depth_right_shift_chroma) { | |
| if(bit_depth_restoration_flag == 0){ | |
| bit_depth_left_shift_chroma | u(3) |
| } | |
| } | |
| } | |
| } | |

According to one or more embodiments, restoration functions may be employed for luma and/or chroma bit-depth restoration. In one or more examples, the same restoration function is applied to all pixels in every color channel. In one or more examples, the restored pixel values at location (x,y) in one or more color channel is restored as: Eq. (1):

$${p}_{r} ( x , y ) = {p}_{o} ( x , y ) \cdot \frac{{p}_{max}}{{2}^{b}} ,$$

where pₒ(x,y) is the original pixel value at location (x,y) in one color channel, pₘₐₓ is the maximum pixel value at the current color channel and b is the target bit-depth to restore to.

In one or more examples, different restoration functions may be applied depending on the pixel location inside the current color channel. In one or more examples, different restoration functions may be applied depending on the pixel value. In one or more examples, different restoration functions are applied to different color channels. In one or more examples, different restoration functions are applied depending jointly on any combination of pixel location, pixel value, and color channel type.

According to one or more embodiments, machine learning algorithms and/or deep learning networks may be employed to learn the restoration for luma and/or chroma bit-depth restoration. According to one or more embodiments, hybrid methods that combine both machine learning machine learning algorithms and/or deep learning networks and restoration function are employed to the same color channel.

According to one or more embodiments, a method to avoid conflicts between bit-depth truncation and other coding tools. This method addresses interoperability and conflict mitigation between bit-depth truncation, coloration and luma enhancement tools, and post filtering and contrast normalization tools. The method ensures that all relevant tools are integrated together without redundancy and conflict in syntax and semantics, thereby enhancing the overall coding efficiency and maintainability.

TABLE 16

| | Descriptor |
|---|---|
| bit_depth_shift( ) { | |
| bit_depth_right_shift_luma | u(3) |
| bit_depth_right_shift_chroma | u(3) |
| if( bit_depth_right_shift_luma > 0) { | |
| bit_depth_left_shift_luma | u(3) |
| if (bit_depth_right_shift_luma == 1) | |
| && (bit_depth_left_shift_luma == 1) | |
| && (bit_depth_right_shift_chroma == 0) | |
| bit_depth_post_filter | u(1) |
| } | |
| if( bit_depth_right_shift_chroma > 0 ) { | |
| bit_depth_left_shift_chroma | u(3) |
| bit_depth_luma_n_contrast_enhance | u(1) |
| if( bit_depth_luma_n_contrast_enhance ) | |
| contast_enhance_thresh_ratio | u(2) |
| byte_alignment( ) | |
| } | |

In one or more examples, bit_depth_right_shift_luma specifies the number of bits that luma sample values are right shifted by the encoder. When not present, the value of bit_depth_right_shift_luma is inferred to be equal to 0. This value may be used to perform temporary left-shift in colorization process, if enabled. The values of bit_depth_right_shift_luma shall be in the range of 0 to 7, inclusive.

In one or more examples, bit_depth_left_shift_luma specifies the number of bits that luma sample values may be left shifted by the decoder. When not present, the value of bit_depth_left_shift_luma is inferred to be equal to 0. The values of bit_depth_left_shift_luma shall be in the range of 0 to 7, inclusive. The value of bit_depth_left_shift_luma shall not exceed the value of bit_depth_right_shift_luma.

In one or more examples, bit_depth_right_shift_chroma specifies the number of bits that chroma sample values are right shifted by the encoder. When not present, the value of bit_depth_right_shift_chroma may be inferred to be equal to 0. The values of bit_depth_right_shift_chroma shall be in the range of 0 to 7, inclusive.

In one or more examples, bit_depth_left_shift_chroma specifies the number of bits that chroma sample values are left shifted. When not present, the value of bit_depth_left_shift_chroma may be inferred to be equal to 0. The values of bit_depth_left_shift_chroma shall be in the range of 0 to 7, inclusive. The value of bit_depth_left_shift_chroma shall not exceed the value of bit_depth_right_shift_chroma.

In one or more examples, bit_depth_luma_n_contrast_enhance equal to 1 specifies that luma enhancement is enabled. bit_depth_luma_n_contrast_enhance equal to 0 specifies that luma enhancement is disabled. When not present, the value of bit_depth_luma_n_contrast_enhance is inferred to be equal to 0.

In one or more examples, contrast_enhance_thresh_ratio specifies the contrast enhancement threshold of the contrast normalization-based contrast enhancement. The values of contrast_enhance_threshold_ratio shall be in the range of 0 to 3, inclusive. When not present, the value of bit_depth_luma_n_contrast_enhance is inferred to be equal to 0. Variable CntrstThRatio is assigned 0, 6, 7, and 8 when contrast_enhance_thresh_ratio equals to 0, 1, 2, and 3, respectively.

In one or more examples, bit_depth_post_filter equal to 1 specifies that the post filtering is enabled. bit_depth_post_filter equal to 0 specifies that the post filtering is disabled. When not present, the value of bit_depth_post_filter is inferred to be equal to 0.

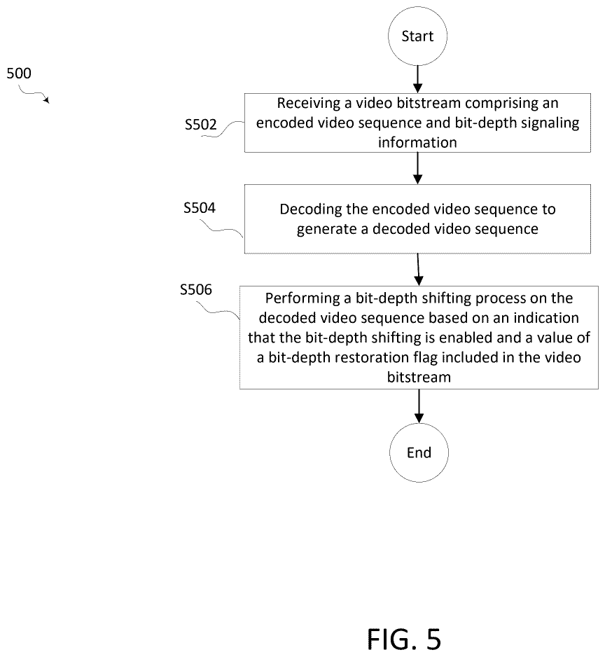

FIG. 5 illustrates a flowchart of an example process 500 for performing bit-depth shifting. The process 500 may be performed by the video decoder 210.

The process may start at operation S502 where a video bitstream that includes an encoded video sequence and bit0depth signaling information is received. The process proceeds to operation S504 where the encoded video sequence is decoded to generate a decoded video sequence. The process proceeds to operation S506 where a bit-depth shifting process on the decoded video sequence is performed based on an indication that bit-depth shifting is enabled and a value of a bit-depth restoration flag included in the video bitstream. In one or more examples, the indication that bit-depth shifting is enabled is a flag in the video bitstream for sequence restoration or picture restoration.

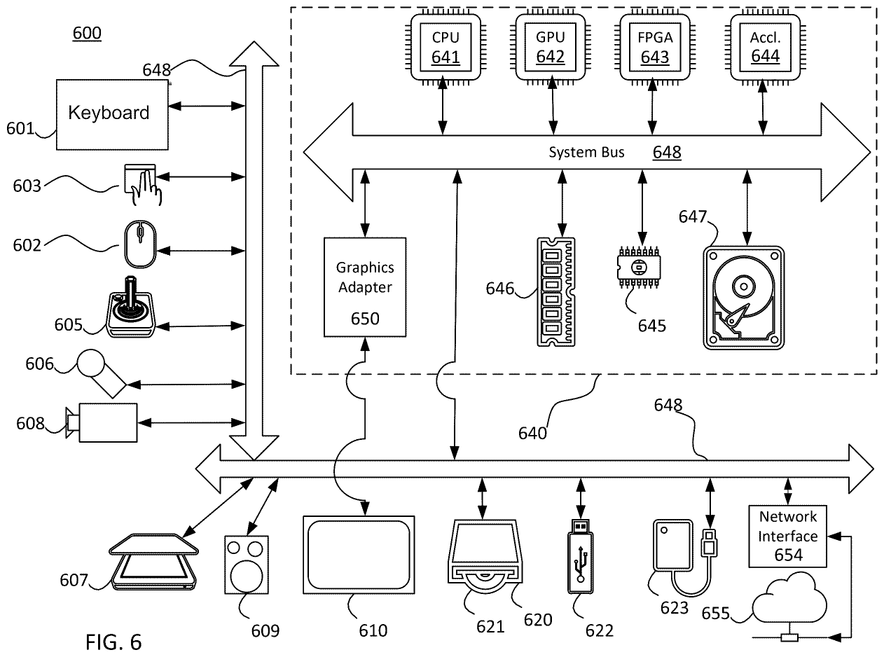

The techniques, described above, may be implemented as computer software using computer-readable instructions and physically stored in one or more computer-readable media. For example, FIG. 6 shows a computer system 600 suitable for implementing certain embodiments of the disclosure.

The computer software may be coded using any suitable machine code or computer language, that may be subject to assembly, compilation, linking, or like mechanisms to create code including instructions that may be executed directly, or through interpretation, micro-code execution, and the like, by computer central processing units (CPUs), Graphics Processing Units (GPUs), and the like.

The instructions may be executed on various types of computers or components thereof, including, for example, personal computers, tablet computers, servers, smartphones, gaming devices, internet of things devices, and the like.

The components shown in FIG. 6 for computer system 600 are examples and are not intended to suggest any limitation as to the scope of use or functionality of the computer software implementing embodiments of the present disclosure. Neither should the configuration of components be interpreted as having any dependency or requirement relating to any one or combination of components illustrated in the non-limiting embodiment of a computer system 600.

Computer system 600 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices may also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 601, mouse 602, trackpad 603, touch screen 610, data-glove, joystick 605, microphone 606, scanner 607, camera 608.

Computer system 600 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 610, data glove, or joystick 605, but there may also be tactile feedback devices that do not serve as input devices). For example, such devices may be audio output devices (such as: speakers 609, headphones (not depicted)), visual output devices (such as screens 610 to include CRT screens, LCD screens, plasma screens, OLED screens, each with or without touch-screen input capability, each with or without tactile feedback capability some of which may be capable to output two dimensional visual output or more than three dimensional output through means such as stereographic output; virtual-reality glasses (not depicted), holographic displays and smoke tanks (not depicted)), and printers (not depicted).

Computer system 600 may also include human accessible storage devices and their associated media such as optical media including CD/DVD ROM/RW 620 with CD/DVD or the like media 621, thumb-drive 622, removable hard drive or solid state drive 623, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 600 may also include interface to one or more communication networks. Networks may be wireless, wireline, optical. Networks may further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses 649 (such as, for example USB ports of the computer system 600; others are commonly integrated into the core of the computer system 600 by attachment to a system bus as described below (for example Ethernet interface into a PC computer system or cellular network interface into a smartphone computer system). Using any of these networks, computer system 600 may communicate with other entities. Such communication may be uni-directional, receive only (for example, broadcast TV), uni-directional send-only (for example CANbus to certain CANbus devices), or bi-directional, for example to other computer systems using local or wide area digital networks. Such communication may include communication to a cloud computing environment 655. Certain protocols and protocol stacks may be used on each of those networks and network interfaces as described above.

Aforementioned human interface devices, human-accessible storage devices, and network interfaces 654 may be attached to a core 640 of the computer system 600.

The core 640 may include one or more Central Processing Units (CPU) 641, Graphics Processing Units (GPU) 642, specialized programmable processing units in the form of Field Programmable Gate Areas (FPGA) 643, hardware accelerators for certain tasks 644, and so forth. These devices, along with Read-only memory (ROM) 645, Random-access memory 646, internal mass storage such as internal non-user accessible hard drives, SSDs, and the like 647, may be connected through a system bus 648. In some computer systems, the system bus 648 may be accessible in the form of one or more physical plugs to enable extensions by additional CPUs, GPU, and the like. The peripheral devices may be attached either directly to the core's system bus 648, or through a peripheral bus 649. Architectures for a peripheral bus include PCI, USB, and the like. A graphics adapter 650 may be included in the core 640.

CPUs 641, GPUs 642, FPGAs 643, and accelerators 644 may execute certain instructions that, in combination, may make up the aforementioned computer code. That computer code may be stored in ROM 645 or RAM 646. Transitional data may be also be stored in RAM 646, whereas permanent data may be stored for example, in the internal mass storage 647. Fast storage and retrieve to any of the memory devices may be enabled through the use of cache memory, that may be closely associated with one or more CPU 641, GPU 642, mass storage 647, ROM 645, RAM 646, and the like.

The computer readable media may have computer code thereon for performing various computer-implemented operations. The media and computer code may be those specially designed and constructed for the purposes of the present disclosure, or they may be of the kind well known and available to those having skill in the computer software arts.

As an example and not by way of limitation, the computer system having architecture 600, and specifically the core 640 may provide functionality as a result of processor(s) (including CPUs, GPUs, FPGA, accelerators, and the like) executing software embodied in one or more tangible, computer-readable media. Such computer-readable media may be media associated with user-accessible mass storage as introduced above, as well as certain storage of the core 640 that are of non-transitory nature, such as core-internal mass storage 647 or ROM 645. The software implementing various embodiments of the present disclosure may be stored in such devices and executed by core 640. A computer-readable medium may include one or more memory devices or chips, according to particular needs. The software may cause the core 640 and specifically the processors therein (including CPU, GPU, FPGA, and the like) to execute particular processes or particular parts of particular processes described herein, including defining data structures stored in RAM 646 and modifying such data structures according to the processes defined by the software. In addition or as an alternative, the computer system may provide functionality as a result of logic hardwired or otherwise embodied in a circuit (for example: accelerator 644), which may operate in place of or together with software to execute particular processes or particular parts of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

The above proposed process can be implemented in an image and/or video decoding process or an image and/or video encoding process. The decoding/encoding process can be used in a video decoder device. Additionally, the decoding/encoding process can also be used in a video encoder device. In some embodiments, the process is executed by processing circuitry, such as the processing circuitry that performs functions of the video decoder, the processing circuitry that performs functions of the video decoder, and the like. In other embodiments, the process is executed by processing circuitry, such as the processing circuitry that performs functions of the video encoder, the processing circuitry that performs functions of the video encoder, and the like. In some embodiments, the process is implemented in software instructions, thus when the processing circuitry executes the software instructions, the processing circuitry performs the process. In other embodiments, the process can be implemented on the chip as a hardware process, thus when the processing circuitry executes the hardware instructions, the processing circuitry performs the process. The process can be suitably adapted. Steps in the process as described above can be modified and/or omitted. Additional steps can be added. Any suitable order of implementation can be used.

The techniques described above, can be implemented as computer software using computer readable instructions and physically stored in one or more computer-readable media. For example, a computer system can be suitable for implementing certain embodiments of the disclosed subject matter. The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like. The instructions can be executed on various types of computers or components thereof, including, for example, personal computers, tablet computers, servers, smartphones, gaming devices, internet of things devices, and the like. The components for computer system are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system. Those skilled in the art should also understand that term “computer readable media” as used in connection with the presently disclosed subject matter does not encompass transmission media, carrier waves, or other transitory signals.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several non-limiting embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the embodiments listed below:

(1) A method performed by at least one processor of a video decoder, the method including: receiving a video bitstream comprising an encoded video sequence and bit-depth signaling information; decoding the encoded video sequence to generate a decoded video sequence; and performing a bit-depth shifting process on the decoded video sequence based on an indication that bit-depth shifting is enabled and a value of a bit-depth restoration flag included in the video bitstream.

(2) The method according to feature (1), in which the indication that bit-depth shifting is enabled is a flag in the video bitstream for sequence restoration or picture restoration.

(3) The method according to feature (1) or (2), in which when the bitstream includes a parameter indicating that a number of bits right shifted for a luma component at an encoder is greater than zero, the bitstream includes the bit-depth restoration flag.

(4) The method according to feature (3), in which the bit-depth restoration flag has a value indicating that a bit-depth restoration process is disabled, the bitstream includes a parameter indicating a number of bits to left shift the luma component at the decoder.

(5) The method according to feature (3), in which when the bitstream includes the parameter indicating that the number of bits right shifted for the luma component at the encoder is greater than zero, the bitstream further includes a luma enhancement enabling flag.

(6) The method according to feature (3), in which the bitstream includes the luma enhancement flag when the bit-depth restoration flag includes a value including that a bit-depth restoration process is disabled.

(7) The method according to feature (4), in which the bitstream includes a luma enhancement enabling flag based on a value of the number of bits to left shift the luma component at the decoder.

(8) The method according to feature (7), in which the bitstream includes the luma enhancement enabling flag when the value of the number of bits to left shift the luma component at the decoder is 0.

(9) The method according to feature (1), in which the bitstream includes a first parameter indicating a number of bits a chroma component is right shifted at an encoder, and in which when the first parameter is greater than zero, the bitstream includes a second parameter indicating a number of bits to shift the chroma component left at the decoder.

(10) The method according to feature (1), in which the bit-depth restoration flag is a bit-depth restoration chroma flag, in which the bitstream includes a first parameter indicating a number of bits a chroma component is right shifted at an encoder, and in which when the first parameter is greater than zero and the bit-depth restoration chroma flag is a value indicating that a bit-depth restoration process for the chroma component is disabled, the bitstream includes a second parameter indicating a number of bits to shift the chroma component left at the decoder.

(11) The method according to feature (1), in which when the bit-depth restoration flag is enabled, one or more restoration functions are employed for luma bit depth restoration and/or chroma bit-depth restoration.

(12) The method according to feature (11), in which a same restoration function is applied to each pixel in each color channel.

(13) The method according to feature (12), in which a restored pixel value at a location in a color channel is restored based on an original pixel value at the location in the color channel, a maximum pixel value at the current channel, and a target restoration bit-depth.

(14) The method according to feature (11), in which different restoration functions are applied based on a pixel location include a current color channel.

(15) The method according to feature (11), in which different restoration functions are applied based on a pixel value.

(16) The method according to feature (11), in which different restoration functions are applied to different color channels.

(17) The method according to any one of the features (11)-(16), in which one or more machine learning algorithms or one or more deep learning networks are used to learn the one or more restoration functions.

(18) The method according to feature (17), in which a combination of the one or more machine learning algorithms and the one or more deep learning networks are used to learn the one or more restoration functions for a same color channel.

(19) A method performed by at least one processor in an encoder including: receiving a video sequence; performing a bit-depth shifting process on the video sequence to generate a transformed video sequence; encoding the transformed video sequence to generate an encoded video sequence; and generating a video bitstream comprising the encoded video sequence and an indication that bit-depth shifting is enabled and a bit-depth restoration flag.

(20) A non-transitory computer readable medium storing a video bitstream that is decoded by a method including: receiving a video bitstream comprising an encoded video sequence and bit-depth signaling information; decoding the encoded video sequence to generate a decoded video sequence; and performing a bit-depth shifting process on the decoded video sequence based on an indication that bit-depth shifting is enabled and a value of a bit-depth restoration flag included in the video bitstream.

What is claimed is:

1. A method performed by at least one processor of a video decoder, the method comprising:
receiving a video bitstream comprising an encoded video sequence and bit-depth signaling information;
decoding the encoded video sequence to generate a decoded video sequence; and
performing a bit-depth shifting process on the decoded video sequence based on an indication that bit-depth shifting is enabled and a value of a bit-depth restoration flag included in the video bitstream.

2. The method according to claim 1, wherein the indication that bit-depth shifting is enabled is a flag in the video bitstream for sequence restoration or picture restoration.

3. The method according to claim 1, wherein when the bitstream includes a parameter indicating that a number of bits right shifted for a luma component at an encoder is greater than zero, the bitstream includes the bit-depth restoration flag.

4. The method according to claim 3, wherein the bit-depth restoration flag has a value indicating that a bit-depth restoration process is disabled, the bitstream includes a parameter indicating a number of bits to left shift the luma component at the decoder.

5. The method according to claim 3, wherein when the bitstream includes the parameter indicating that the number of bits right shifted for the luma component at the encoder is greater than zero, the bitstream further includes a luma enhancement enabling flag.

6. The method according to claim 3, wherein the bitstream includes the luma enhancement flag when the bit-depth restoration flag includes a value including that a bit-depth restoration process is disabled.

7. The method according to claim 4, wherein the bitstream includes a luma enhancement enabling flag based on a value of the number of bits to left shift the luma component at the decoder.

8. The method according to claim 7, wherein the bitstream includes the luma enhancement enabling flag when the value of the number of bits to left shift the luma component at the decoder is 0.

9. The method according to claim 1, wherein the bitstream includes a first parameter indicating a number of bits a chroma component is right shifted at an encoder, and wherein when the first parameter is greater than zero, the bitstream includes a second parameter indicating a number of bits to shift the chroma component left at the decoder.

10. The method according to claim 1, wherein the bit-depth restoration flag is a bit-depth restoration chroma flag, wherein the bitstream includes a first parameter indicating a number of bits a chroma component is right shifted at an encoder, and wherein when the first parameter is greater than zero and the bit-depth restoration chroma flag is a value indicating that a bit-depth restoration process for the chroma component is disabled, the bitstream includes a second parameter indicating a number of bits to shift the chroma component left at the decoder.

11. The method according to claim 1, wherein when the bit-depth restoration flag is enabled, one or more restoration functions are employed for luma bit depth restoration and/or chroma bit-depth restoration.

12. The method according to claim 11, wherein a same restoration function is applied to each pixel in each color channel.

13. The method according to claim 12, wherein a restored pixel value at a location in a color channel is restored based on an original pixel value at the location in the color channel, a maximum pixel value at the current channel, and a target restoration bit-depth.

14. The method according to claim 11, wherein different restoration functions are applied based on a pixel location include a current color channel.

15. The method according to claim 11, wherein different restoration functions are applied based on a pixel value.

16. The method according to claim 11, wherein different restoration functions are applied to different color channels.

17. The method according to claim 11, wherein one or more machine learning algorithms or one or more deep learning networks are used to learn the one or more restoration functions.

18. The method according to claim 17, wherein a combination of the one or more machine learning algorithms and the one or more deep learning networks are used to learn the one or more restoration functions for a same color channel.

19. A method performed by at least one processor in an encoder, the method comprising:
receiving a video sequence;
performing a bit-depth shifting process on the video sequence to generate a transformed video sequence;
encoding the transformed video sequence to generate an encoded video sequence; and
generating a video bitstream comprising the encoded video sequence and an indication that bit-depth shifting is enabled and a bit-depth restoration flag.

20. A non-transitory computer readable medium storing a video bitstream that is decoded by a method comprising:
receiving a video bitstream comprising an encoded video sequence and bit-depth signaling information;
decoding the encoded video sequence to generate a decoded video sequence; and
performing a bit-depth shifting process on the decoded video sequence based on an indication that bit-depth shifting is enabled and a value of a bit-depth restoration flag included in the video bitstream.
